(19) United States
(12) Patent Application Publication
(10) Pub. No.: US 2011/0006259 A1
(43) Pub. Date: Jan. 13, 2011

(54) CONTINUOUS PROCESS FOR PERFORMING A REACTION

(75) Inventor: Chris DeArmitt, Hattiesburg, MS (US)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/297,000

(22) PCT Filed: Apr. 4, 2007
(86) PCT No.: PCT/EP2007/053301

§ 371 Date: Jul. 10, 2009

(30) Foreign Application Priority Data
Apr. 11, 2006 (EP) 06112480.6

(51) Int. Cl. C09K 3/00

(52) U.S. Cl. 252/182.32

(57) ABSTRACT

A continuous process is proposed for performing a reaction, in which a feed stream (1) comprising a continuous liquid phase I forms a liquid phase II and/or one or more solid phases whose density is greater than the density of the continuous liquid phase I of the feed stream (1), which is carried out in a hydrocyclone (R) to which the feed stream (1) comprising the continuous liquid phase I is fed tangentially, the reaction takes place in the hydrocyclone (R) to obtain a reaction mixture comprising the continuous liquid phase II which is formed in the reaction and the reaction mixture is separated in the hydrocyclone (R) under the action of centrifugal force in such a way that a product stream comprising a substream or the entire stream of the continuous liquid phase II and all phases whose density is lower than the density of the continuous liquid phase II is drawn off radially at the upper end of the hydrocyclone (R), and a stream which comprises all solid phases having a density greater than the density of the continuous liquid phase II and any substream of the continuous phase II not drawn off via the product stream is drawn off at the lower end of the hydrocyclone (R).

The invention relates to a continuous process for performing a reaction, in which one feed stream comprising a continuous liquid phase forms one or more liquid and/or solid phases whose density is greater than the density of the continuous liquid phase of the feed stream, and to use thereof.

Numerous processes are known in which a feed stream comprising a continuous liquid phase forms one or more liquid and/or solid phases which have to be separated from one another.

Also known are processes in which, from a stream comprising a continuous liquid phase and additionally a liquid and/or a gaseous and/or a solid phase, one or more phases whose density is greater than the density of the continuous liquid phase have to be removed.

It is known, for example, that magnesium hydrogencarbonate solutions can be prepared from aqueous suspensions of magnesium salts by introducing carbon dioxide. The reaction is frequently carried out in stirred tanks. Since it is an equilibrium reaction, the rise in the magnesium hydrogencarbonate concentration in the solution is initially steep but flattens out greatly with increasing conversion. In order to obtain certain predefined concentrations, uneconomically long reaction times are therefore frequently required.

It was accordingly an object of the invention to provide a process which can be performed continuously in an apparatus without moving apparatus parts, whose operation is thus not prone to faults, and which efficiently provides, with short reaction times, desired predefined concentrations of products of value in a continuous liquid phase.

The solution consists in a continuous process for performing a reaction, in which a feed stream comprising a continuous liquid phase I forms a liquid phase II whose density is greater than the density of the continuous liquid phase I of the feed stream and if appropriate one or more solid phases, which is carried out in a hydrocyclone to which the feed stream comprising the continuous liquid phase I is fed tangentially, the reaction takes place in the hydrocyclone to obtain a reaction mixture comprising the continuous liquid phase II and if appropriate one or more solid phases which are formed in the reaction and the reaction mixture is separated in the hydrocyclone under the action of centrifugal force in such a way that a product stream comprising a substream or the entire stream of the continuous liquid phase II and all phases whose density is lower than the density of the continuous liquid phase II is drawn off radially at the upper end of the hydrocyclone, and a stream which comprises all solid phases having a density greater than the density of the continuous liquid phase II and any substream of the continuous phase II not drawn off via the product stream is drawn off at the lower end of the hydrocyclone.

The hydrocyclones used may be commercial and correspondingly inexpensive apparatus. As is well known, this apparatus is in the form of upright cylinders which narrow in a generally conical manner at their lower end. While cyclones are operated with gaseous feed streams, the feed streams in hydrocyclones comprise a continuous liquid phase.

By virtue of a feed stream being fed through a tangential feed orifice, especially under pressure, it passes through the apparatus from the top downward, a separation proceeding on the basis of the density differences under the action of centrifugal force: phases of higher density are thrown to the periphery, collect on the inner walls of the apparatus and can be drawn off via the outlet at the lower end of the frequently conical region. In contrast, phases of lower density remain in the center of the apparatus and can be drawn off via an orifice arranged radially at the upper end thereof.

In one embodiment of the invention, the feed stream comprises, in addition to a continuous liquid phase I, a gaseous phase and/or one or more solid phases. The feed stream comprising a continuous liquid phase I is fed tangentially to the hydrocyclone, whereupon the reaction to form a reaction mixture comprising a continuous liquid phase II whose density is greater than the density of the continuous liquid phase I from the feed stream takes place within the hydrocyclone. In the hydrocyclone, under the action of centrifugal force, all liquid and/or solid phases whose density is greater than the density of the continuous liquid phase II of the product mixture are removed and drawn off at the lower end thereof. From the continuous liquid phase II, a substream is frequently drawn off at the upper end of the cyclone and via the product stream, and the remaining substream is drawn off at the lower end of the cyclone. In one process version, the entire stream of the continuous liquid phase III is drawn off via the product stream, at the upper end of the hydrocyclone.

Since, owing to the way in which the hydrocyclone functions, all phases whose density is greater than the density of the continuous liquid phase II of the reaction mixture are removed therein, the apparatus is suitable in particular also for working up return streams which have been contaminated with liquid and/or solid components to be removed, for example with rubber particles.

Advantageously, for example, the concentrated stream drawn off at the lower end of the hydrocyclone can be recycled again into the hydrocyclone, into the feed stream.

In accordance with the specific requirements of the reaction to be performed, the hydrocyclone can be heated or cooled.

Advantageously, for example, an outer jacket can be provided to accommodate a heat exchanger.

Depending on the specific requirements of the reaction to be performed, the hydrocyclone may be equipped with devices for generating ultrasound.

In the process according to the invention, the feed stream may advantageously comprise water as the continuous liquid phase I, a magnesium salt as the solid phase and carbon dioxide as the gaseous phase. In this case, a product stream comprising an aqueous magnesium hydrogencarbonate solution as the continuous liquid phase II whose density is greater than the density of water (continuous liquid phase I) is drawn off. This can be obtained preferably in a concentration between 1 and 3% by weight, more preferably between 1 and 2.5% by weight, preferably between 1 and 2% by weight, of magnesium hydrogencarbonate. Moreover, the product stream may comprise further solid and/or gaseous phases whose density is greater than the density of the continuous liquid phase II (aqueous magnesium hydrogencarbonate solution), especially rubber particles.

It is also possible to premix the suspension of a magnesium salt with carbon dioxide and to feed this mixture subsequently as the feed stream to the hydrocyclone.

The feed stream is fed to the hydrocyclone advantageously under pressure, in particular at a pressure of up to 10 bar absolute, preferably between 1 and 6 bar absolute.

Depending on the specific requirements of the reaction to be performed, it is possible to use 1, 2 or more hydrocyclones, in parallel and/or in series.

In an advantageous process variant, the same reaction as in the hydrocyclone can first be carried out in a first process stage in a high-speed mixer, in which case the reaction mixture drawn off from the high-speed mixer is fed to the hydrocyclone as the feed stream. The high-speed mixer thus has the function of a prereactor in which the reaction is conducted up to a certain conversion which is lower than the residual conversion which is achieved in the downstream process step in the hydrocyclone. This process version is particularly advantageous in the case of equilibrium reactions with an initially sharp rise in the conversion at the start of the reaction but which flattens out greatly as the reaction advances.

The invention will be illustrated in detail below with reference to a figure.

The figure shows:

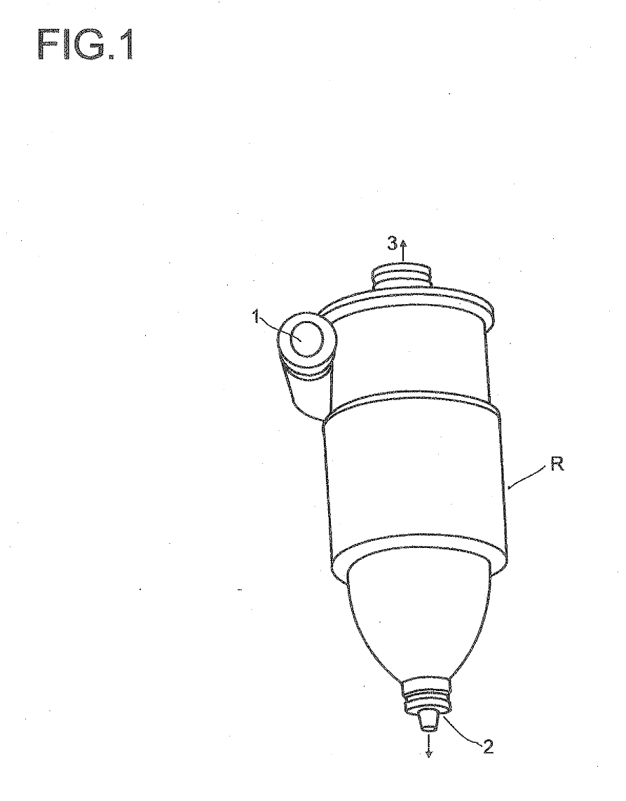

FIG. 1—the schematic diagram of a hydrocyclone for use in a process according to the invention.

The hydrocyclone (R) shown schematically in FIG. 1 has an upper tangential feed orifice for a feed stream 1, a lower central removal orifice for a stream 2 and an upper central removal orifice for the product stream 3.

1.-21. (canceled)

22. A process for performing a reaction to form an aqueous solution of magnesium hydrogencarbonate, the process comprising:
tangentially feeding a feed stream into a hydrocyclone, the feed stream comprising water, a magnesium salt, and carbon dioxide;
obtaining a reaction mixture comprising an aqueous solution of magnesium hydrogencarbonate by a reaction taking place in the hydrocyclone;
separating the reaction mixture in the hydrocyclone by centrifugal force;
radially drawing off, from an upper end of the hydrocyclone, a product stream comprising at least a substream of the aqueous solution of magnesium hydrogencarbonate; and
radially drawing off, from a lower end of the hydrocyclone, a concentrated stream comprising all phases and having a density greater than the density of the aqueous solution of magnesium hydrogencarbonate and any substream of the aqueous solution of magnesium hydrogencarbonate not drawn off via the product stream, wherein a concentration of the product stream is 1 to 3% by weight of magnesium hydrogencarbonate.

23. The process of claim 22, wherein the feed stream further comprising at least one of a gaseous phase and one or more solid phases.

24. The process of claim 22, further comprising heating or cooling the the hydrocyclone.

25. The process of claim 24, wherein heating or cooling the hydrocyclone includes heating or cooling the hydrocyclone with an outer jacket.

26. The process of claim 22, wherein the hydrocyclone includes devices for generating ultrasound.

27. The process of claim 22, wherein the concentration of the product stream is from 1 to 3% by weight of magnesium hydrogencarbonate.

28. The process of claim 22, wherein the feed stream comprises a suspension of the magnesium salt which has been premixed with carbon dioxide.

29. The process of claim 22, wherein two or more hydrocyclones are used in parallel and/or in series.

30. The process of claim 22, wherein the concentrated stream is recycled into the feed stream.

31. The process of claim 22, wherein the feed stream is a reaction mixture stream from a high-speed mixer in which the same reaction has been carried out as in the hydrocyclone but at a lower conversion than in the hydrocyclone.
